(19) United States
(12) Patent Application Publication
(10) Pub. No.: US 2024/0095489 A1
(43) Pub. Date: Mar. 21, 2024

(54) Personality-Based Intelligent Personal Assistant System

(71) Applicant: Bayerische Motoren Werke Aktiengesellschaft, Muenchen (DE)

(72) Inventors: Hannah KOPP, Taufkirchen (DE); Andreas SCHARTNER, Feldkirchen-Westerham (DE)

(21) Appl. No.: 17/767,964

(22) PCT Filed: Nov. 29, 2019
(86) PCT No.: PCT/CN2019/122021

§ 371 Date: Apr. 11, 2022

(51) Int. Cl. G06N 3/006; G06F 3/16; G06F 9/451; G10L 13/033

(52) U.S. Cl. CPC G06N 3/006; G06F 3/167; G06F 9/453; G10L 13/033; G06F 3/011

(57) ABSTRACT

A personality-based intelligent personal assistant IPA system, includes at least a first entity, which is adapted to determine a user's preferences with regard to the provision of information, and at least a second entity, which is adapted to receive the first entity's determination result. The system is further adapted to adjust the IPA's attributes regarding communication behavior with the user according to the determined user's preferences, wherein the communication behavior attribute comprises an amount of provided information to the user, a frequency of system-initiated interaction, a proactivity of automation, and/or an integration of third-party content.

### BACKGROUND AND SUMMARY

The invention refers to a personality-based intelligent personal assistant (IPA) system.

There are currently numerous systems on the market and in development concerning Intelligent Personal Assistants (IPA). These IPA-systems allow the user to interact in a natural way, preferably via so-called Voice Control, with a technical system. Those systems assist the user with personalized suggestions using various forms of interaction, e.g. speech prompts, graphical displays, as well as various devices, e.g. smart phones, personal computers, speakers, in order to interact with the user. As a result of the manner of communication and the content of the messages, a character is formed, which varies from technical to personal. This character is normally a result of the intended design by the developing company. Also, systems are already known that can adapt to the actual user's mood by adjusting their information output.

An example of a known IPA can be found e.g. in US 2015/0371663 A1, in which one or more stereotype characters are used in order to react to a user request. In this document, the IPA's output is adjusted such that a preferred output style, e.g. verbal or written, is chosen and the timing is adjusted to the user's preferences.

However, the known prior art is presently focused on mood recognition by analyzing speech. According to the recognized mood information, an output is provided, which is adapted in order to be in line with the user's mood, i.e. in order either not to change the user's mood or in order to influence the user's mood to be a more positive mood. However, since the known IPA systems only provide one or more stereotype characters, the specific presence of the character is perceived differently by different users. Depending on the preferences of the individual user, this specific presence might be disliked, which will result in a reluctance to use the system.

In order to avoid the conflict of personal preferences and a predefined IPA character, the scope of the present invention is to provide a new IPA specifically for use in a vehicle, which provides a more personalized character and thus results in higher user acceptance. This problem is solved by the personality-based IPA system as described in the independent claims. Specific additional features are addressed in the dependent claims.

Provided is a personality-based intelligent personal assistant IPA system, comprising
at least a first entity, which is adapted to determine user's preferences with regard to provision of information
at least a second entity, which is adapted to receive the first entity's determination result, and which is further adapted to adjust the IPA's attributes regarding communication behavior with the user according to the determined user's preferences, wherein communication behavior attribute comprise:
an amount of provided information to the user, and/or
a frequency of system-initiated interaction, and/or
a proactivity of automation, and/or
an integration of third-party content.

Due to the new personality-based IPA, the specificity of the character can be adjusted in several attributes with respect to the user's preferences in many different ways.

By adjusting the amount of information provided generally or with regard to predetermined topics depending on the preference of the use, a proficiency of the user regarding one or more topics can be taken into account.

By adopting the frequency of communication output by the IPA-system depending on a set priority of issues to be communicated, the system can adjust the frequency of system-initiated interactions in several levels from only notifying the user about the most important issues to keeping him updated on all new information.

Further, third party content is included in the communication tasks of the IPA system. Generally, the IPA is related to a native environment, e.g. the vehicle environment. Hence, it generally only directs its communication to topics which are directly related to this native environment, i.e. the vehicle-based IPA only interacts with vehicle-related topics. By integrating more content, which are e.g. offered by third-party providers like social networks, smart home, news providers, the IPA-system can provide more information and is thus more valuable for the user.

Further, the IPA's attributes, i.e. its communication behavior, are additionally varied regarding the style of speech output, the manner of sound output, the manner of style of written output. Since the way the IPA-system communicates with the user can be varied in matters of the style of speech it uses, both in written and spoken outputs, the user does not feel offended or get annoyed by the way he is addressed by the system or by the way the system outputs information.

Further, the style of speech and/or written output ranges from a technical communication style, using short sentences, abstract words and/or statements, to a communication style, using full sentences, descriptive language, or any style of communication in between. That means that the IPA-system can range from a technical speech to a formal or personal style, defined by the way the system refers to itself, the user and other objects, as well as the amount of padding phrases used.

Further, the kind of voice used for speech output is adjusted using different gender, age or tone, depending on the preference of the user.

Further, the IPA-system uses a learning algorithm, which continuously learns the user's preferences by observing the user's reaction on the provided communication.

As the IPA is learning the user's habits and preferences, it can derive rules to automate functions which are normally controlled manually by the user. Additionally, the proactivity of this ability to automate those functions can be adjusted. The range of service ranges from only automating functions which the user explicitly programs the IPA to do, to asking for permission to start a newly learned automation task and executing a new rule independently unless told to refrain from doing so.

Further, adjustment of the IPA's attributes can either be offered to be done manually by the user or it can be adjusted automatically, e.g. based on an interpretation of reactions of the user.

Further, the adjustment of the attributes can either be offered independently, or their specific values can be grouped into several consistent characters. Example characters are characters that are one of being calm and considered, lively and talkative, and/or using only short sentences, and/or using sophisticated language, that are quiet or loud. Hence, a predefined character can be provided that has a bunch of attributes matched to each other.

Further, the intelligent personal assistant system is used in an automotive environment.

These and/or other aspects will become apparent and more readily appreciated from the following description of the exemplary embodiments, taken in conjunction with the accompanying drawing.

### BRIEF DESCRIPTION OF THE DRAWING

FIG. 1 shows main components of the IPA according to one embodiment of the present invention.

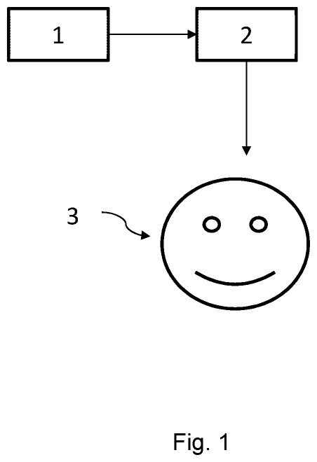

### DETAILED DESCRIPTION OF THE DRAWING

The basic principle of the invention is to provide an IPA, which provides communication to the user 3 based on the user's 3 personality.

Presently, there are some IPA systems that focus on detailed communication issues like recognition of a user's 3 mood, e.g. whether the user 3 is tired or inattentive. With this information, a stereotype, i.e. predefined, character of the IPA is used to communicate with the user 3.

However, for those IPA systems only standardized characters are available, which do not adjust their output according to the user's 3 preferences, but only adopt their output in a general, predefined manner in response to a user's 3 input. Hence, due to the present IPA system, an IPA can be generated, whose communication behavior, i.e. the attributes of the communication behavior, can be adjusted to the user's 3 preferences.

In order to achieve this, a first entity 1 is provided, that is adapted to determine a user's 3 preferences with regard to the providing of information. This first entity 1 can be one or more cameras and/or one or more sensors that are adapted to sense the user's 3 physiological condition and other user 3 conditions that are known to be indicators for determining the user's 3 preferences regarding communication behavior. Further, a second entity 2 is provided, which is adapted to receive the first entity's 1 determination result. This second entity 2 is preferably a control unit that is adapted to control the communication output to the user 3 and is further adapted to adjust the IPA's attributes regarding communication behavior with the user 3 according to the determined user's 3 preferences. The communication behavior attributes comprise an amount of information provided to the user 3 and/or a frequency of system-initiated interaction and/or a proactivity of automation and/or an integration of third-party content. By using at least one of those attributes, the IPA becomes more personalized and thus the user's 3 acceptance of the IPA will increase.

The attribute of an amount of information provided to the user 3 refers to how much detailed information is provided as an output of the IPA, especially concerning giving more or less detailed instructions to the user 3.

The attribute of frequency of system-initiated interaction refers to how often the system initiates a dialogue with the user 3. I could be “never”, so that every interaction is initiated by the user 3, or any higher frequency, also depending on the significance of the topic the interaction is about.

The attribute of proactivity of automation refers to the possibility to adjust, whether the IPA independently executes functions based on observed and learned behavior from the user 3 or whether it always asks for permission to adopt a new automation or if it never takes the initiative to begin an automation by itself.

The attribute of integration of third-party content refers to the possibility of allowing or forbidding the IPA from accessing information and functions of third-party offers, e.g. messages on social media, controls of smart home, etc.

The IPA system as described can be used in an automotive environment, e.g. as an assistance system for the driver, or in other technical areas in which a user 3 support by a technical entity is intended or needed.

1.-6. (canceled)

7. A personality-based intelligent personal assistant (IPA) system, comprising:
at least a first entity, which is adapted to determine a user's preferences with regard to providing information; and
at least a second entity, which is adapted to receive a determination result of the first entity, and which is further adapted to adjust attributes of the IPA regarding communication behavior with the user according to the determined user's preferences, wherein communication behavior attributes comprise:
an amount of provided information to the user,
a frequency of system-initiated interaction,
a proactivity of automation, and/or
an integration of third-party content.

8. The personality-based intelligent personal assistant system according to claim 7, wherein
the communication behavior is additionally varied regarding style of speech output, manner of sound output, and/or manner of style of written output.

9. The personality-based intelligent personal assistant system according to claim 7, wherein
the communication behavior is additionally varied regarding kind of voice used for speech output by using different gender, age or tone.

10. The personality-based intelligent personal assistant system according to claim 7, wherein
a learning algorithm is implemented in the first entity, which continuously learns the user's preferences by observing the user's reaction to the provided information.

11. The personality-based intelligent personal assistant system according to claim 7, wherein
the first entity is adapted to create a character comprising several attributes regarding communication behavior of the IPA, which are matched to the determined user's preferences.

12. The personality-based intelligent personal assistant system according to claim 7, wherein the intelligent personal assistant system is used in an automotive environment.
